(19) United States
(12) Patent Application Publication
(10) Pub. No.: US 2014/0104497 A1
(43) Pub. Date: Apr. 17, 2014

(54) VIDEO FILES INCLUDING AMBIENT LIGHT EFFECTS

(71) Applicants: Adam Li, Solana Beach, CA (US); Megan Farrell, San Diego, CA (US); Aixin Liu, San Diego, CA (US); Djung Nguyen, San Diego, CA (US)

(72) Inventors: Adam Li, Solana Beach, CA (US); Megan Farrell, San Diego, CA (US); Aixin Liu, San Diego, CA (US); Djung Nguyen, San Diego, CA (US)

(21) Appl. No.: 13/654,190

(22) Filed: Oct. 17, 2012

(51) Int. Cl. H04N 5/58

(52) U.S. Cl. 348/602; 348/E05.12

(57) ABSTRACT

Methods and systems for controlling ambient light effects associated with video content are provided. The method includes providing a receiving device configured to parse an incoming video file. The video file includes at least one track specifying at least one ambient light effect associated with at least one portion of the video file. The method also includes parsing the video file at the receiving device to separate the track specifying the ambient light effect and sending a command to one or more lighting devices to generate the ambient light effect specified in the track from the receiving device. The lighting device generates the ambient light effect specified in the track when the portion of the video file associated with the ambient light effect is displayed to a user.

### FIELD

This invention relates to ambient light effects, and more specifically, to ambient light effects generated based on information included in a video file.

### BACKGROUND

Television programs, movies, and video games most commonly provide visual stimulation from a television screen display and audio stimulation from the speakers connected to the television. There are some known systems that attempt to enhance a viewer's/user's experience by providing a more interactive/responsive environment. For example, some video gaming systems cause lighting devices such as lamps to generate an ambient light effect (“ALE”) during game play.

To provide an enjoyable interactive experience, the lighting devices need to generate the ambient light effects at appropriate times when the associated scene is displayed to a user. Thus, an ambient light effect-capable system needs to be able to identify one or more scenes during the display of which an ambient light effect is to be generated. One such system focuses on detecting and analyzing various parameters of the video file or video game application and generating ambient light effects based on the detected parameters.

One problem with such an approach is that many video files and video games include various access restrictions imposed by the content providers, and such restrictions may make it difficult or impossible to analyze the parameters of a video file and/or video game. Accordingly, what is needed is a way of producing ambient light effects in association with one or more portions of a video file that overcomes the aforementioned shortcomings.

### SUMMARY

The present invention satisfies this need. In one embodiment, a method of controlling ambient light effects is provided. The method comprises: providing a receiving device configured to parse an incoming video file; receiving the video file at the receiving device, the video file including at least one track specifying at least one ambient light effect associated with at least one portion of the video file and specifying at least one lighting device for generating the at least one ambient light effect specified in the at least one track; parsing the video file at the receiving device to separate the at least one track specifying the at least one ambient light effect and the at least one lighting device; sending a command to generate the at least one ambient light effect specified in the at least one track from the receiving device to the at least one lighting device specified in the at least one track; and causing the at least one lighting device specified in the at least one track, and receiving the command, to generate the at least one ambient light effect specified in the at least one track when the at least one portion of the video file associated with the at least one ambient light effect is displayed.

The receiving device can be selected from one of a television, set-top box, disc player, personal computer, laptop, tablet computer, gaming console, and mobile phone.

The receiving device can include at least one hardware component programmed to parse the video file to separate the at least one track specifying the at least one ambient light effect.

The method can further include providing at least one software component adapted for inserting the at least one track specifying the at least one ambient light effect into the video file.

The at least one track can further include a predetermined location of the at least one lighting device relative to the receiving device. The at least one track can also include a predetermined time when the at least one ambient light effect is to be generated by the at least one lighting device. The at least one track can also include at least one of brightness and rate of flickering of the at least one ambient light effect to be generated by the at least one lighting device.

The at least one portion of the video file can be a predetermined event in a video contained in the video file and the predetermined event can be associated with the at least one ambient light effect.

The method can further include providing a graphical user interface permitting a user to configure one or more options for controlling generation, by the at least one lighting device, of the at least one ambient light effect included in the at least one track.

In one approach, the method can include sending the command from the receiving device to the at least one lighting devices via a wired connection. In another approach, the method can include sending the command from the receiving device to the at least one lighting devices via a wireless connection. In yet another approach, the method can include sending the command from the receiving device to the at least one lighting devices via a home automation system.

A method of making a video file specifying at least one ambient light effect is also provided. The method comprises writing at least one track into a video file, the video track specifying at least one ambient light effect associated with at least one portion of the video file and identifying at least one lighting device for generating the at least one ambient light effect specified in the at least one track; and sending the at least one track in the video file to a receiving device adapted to parse the video file to separate the at least one track, and to send a command to the at least one lighting device specified in the at least one track to generate the at least one ambient light effect specified in the at least one track.

In one approach, the method can further comprise specifying, in the at least one track, a predetermined location of the at least one lighting device relative to the receiving device. In another approach, the method can further comprise specifying, in the at least one track, a predetermined time when the at least one ambient light effect is to be generated by the at least one lighting device. In yet another approach, the method can further comprise specifying, in the at least one track, at least one of brightness and rate of flickering of the at least one ambient light effect to be generated by the at least one lighting device.

In one approach, the method can further include specifying, in the at least one track, a predetermined event in a video contained in the video file which is associated with the at least one ambient light effect. The method can also include specifying in the at least one track, that display of the predetermined event on a display device of a user simultaneously causes generation of the at least one ambient light effect by the at least one lighting device.

A system for controlling ambient light effects is also provided. The system includes a receiving device including at least one hardware component including a processor programmed to parse an incoming video file to separate at least one track specifying at least one ambient light effect associated with at least one portion of the video file, and at least one lighting device in communication with the receiving device. The at least one track can specify the at least one lighting device for generating the at least one ambient light effect. The processor of the receiving device is programmed to send a command from the receiving device to the at least one lighting device specified in the track to generate the at least one ambient light effect. The at least one lighting device includes at least one hardware component adapted to, after receiving the command from the receiving device, to generate the at least one ambient light effect when the at least one portion of the video file associated with the at least one ambient light effect is displayed to a user.

The systems and methods described herein provide an engaging experience to a user when watching television programming, movies, or playing video games. One advantage of the systems and methods described therein is that television programming, movies, and video games can be made more interactive for a user by including ambient light effects can be generated by one or more lighting devices based on information included as additional tracks in the video file representing the television program, movie, or video game. These and other advantages will be apparent upon consideration of the present specification.

### BRIEF DESCRIPTION OF THE DRAWINGS

FIG. 1 is a front view of several exemplary devices for performing a method according to one embodiment;

FIG. 2 is a schematic diagram of the devices shown in FIG. 1;

FIG. 3 is a front view of several exemplary devices for performing a method according to another embodiment;

FIG. 4 is a schematic diagram of the devices shown in FIG. 3;

FIG. 5 is a schematic diagram of several exemplary devices for performing a method according to yet another embodiment; and

FIG. 6 is a schematic diagram illustrating an exemplary video stream and several devices for performing a method according to yet another embodiment.

### DETAILED DESCRIPTION

Reference will now be made in detail to the present preferred embodiments of the invention, examples of which are illustrated in the accompanying drawings.

Generally, systems and methods are described herein for providing ambient light effects for a user when watching television programming, movies, or playing video games. The ambient light effects can be generated by one or more lighting devices based on information included as additional tracks in the video file representing the television program, movie, or video game. The ambient light effects can be associated with various events or action sequences in the television program, movie, or video game, and can be customized by the user through an interactive graphical user interface.

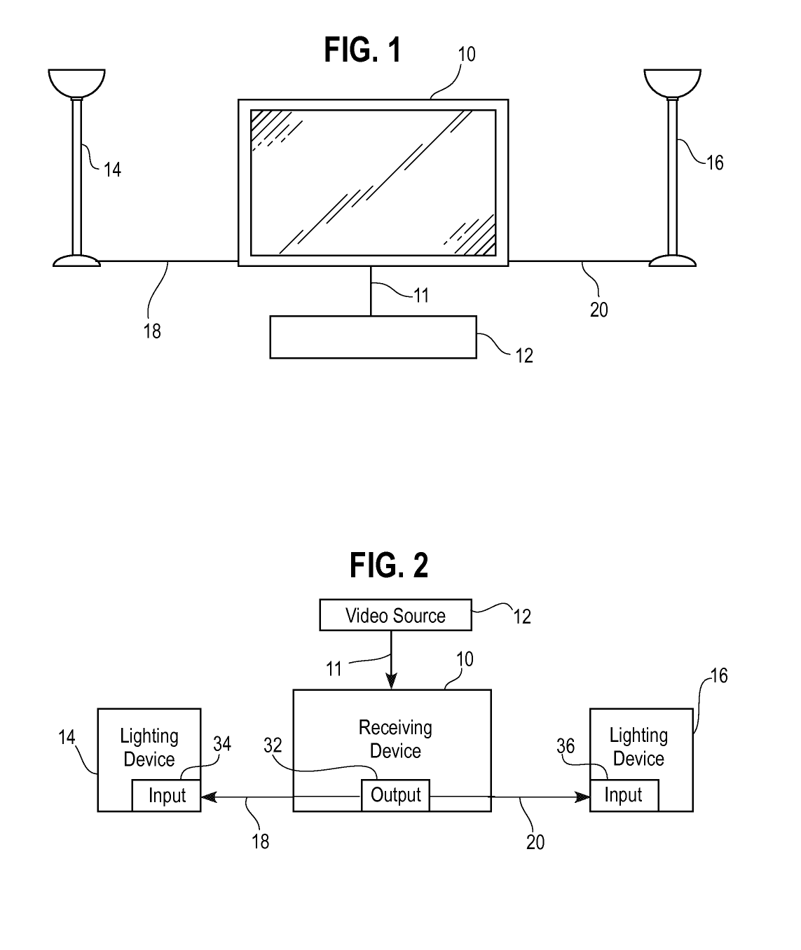

With specific reference to FIG. 1, in one embodiment of a method of controlling ambient light effects, a receiving device 10 receives video files from a video source 12. The receiving device 10 has been illustrated in FIG. 1 as a television. However, it is to be appreciated that the receiving device 10 can be, for example, a set-top box, an optical disc player such as a DVD-player or Blu-Ray player, a portable media player, a personal computer, laptop, tablet computer, gaming console, mobile phone, and the like.

The video source 12 can be any source capable of providing digital video files via a connection 11 to the receiving device 10. The video source 12 can be a cable head-end, a DVD or Blu-Ray disc, a video game disc, hard drive, or a digital media server capable of streaming to the receiving device. Although the connection 11 between the receiving device 10 and the video source 12 is preferably a wired connection, it is to be appreciated that the connection 11 between the receiving device 10 and the video source 12 can also be wireless.

In one approach shown in FIG. 1, the receiving device 10 is directly connected to two lighting devices 14 and 16 via wired connections 18 and 20, respectively. Referring to FIG. 2, which is a schematic representation of FIG. 1, the receiving device 10 has an output 32 and the lighting devices 14 and 16 each have an input 34 and 36, respectively, which can be interconnected by the respective wires or cables 18 and 20 as shown in FIG. 2.

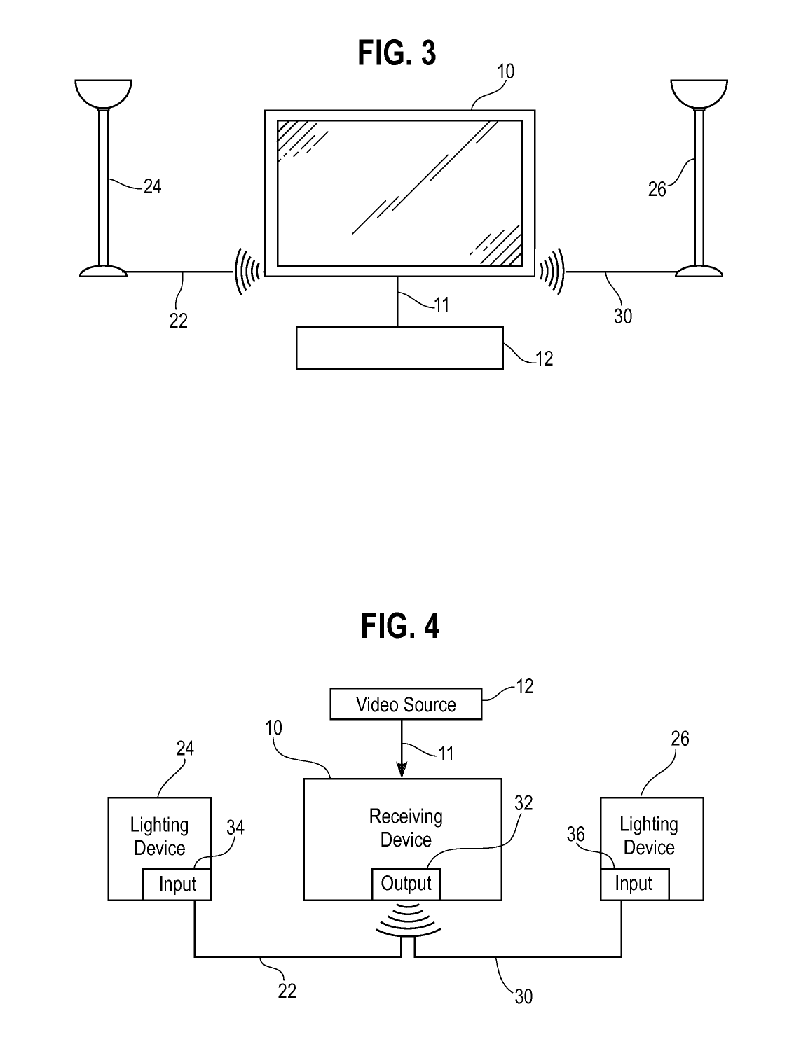

In another approach shown in FIG. 3, the receiving device 10 is in direct communication with two lighting devices 24 and 26 via wireless signals 28 and 30, respectively. Referring to FIG. 4, which is a schematic representation of FIG. 3, the receiving device 10 has an output 32 including a wireless transmitter adapted to transmit wireless signals 28 and 30 to the lighting devices 24 and 26. The lighting devices 24 and 26 have inputs 34 and 36, respectively, each including a wireless receiver adapted to receive the wireless signals 28 and 30 emitted by the wireless transmitter at output 32 of the receiving device 10.

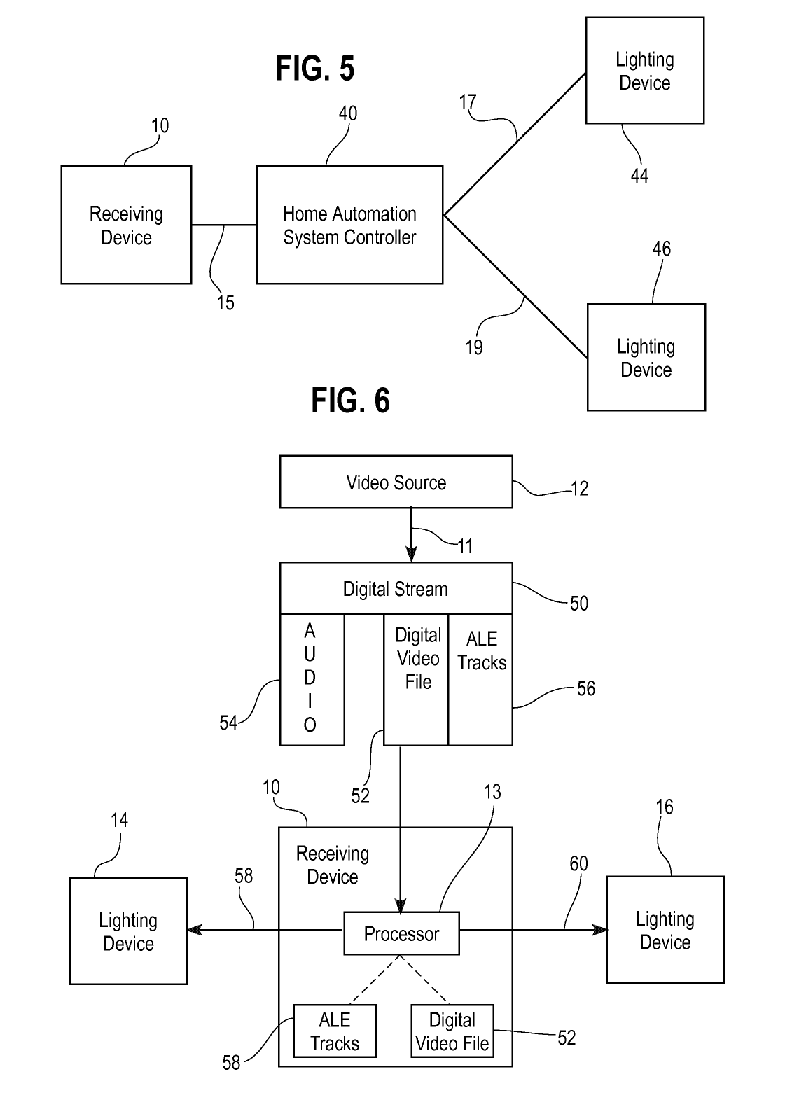

In yet another approach shown in FIG. 5, the receiving device 10 can be indirectly connected to two lighting devices 44 and 46 via a home automation system controller 40. The home automation system controller 40 can be a physical device adapted to control lighting devices 44 and 46 and other household devices. In one approach shown in FIG. 5, the home automation system controller 40 is located separate from the receiving device 10 and connected to the receiving device via a connection 15. The home automation controller 40 is in turn connected to the lighting devices 44 and 46 via connections 17 and 19, respectively. The connections 15, 17 and 19 can be wired or wireless connections. In another approach, the home automation controller 40 can be integrated into the receiving device 10. In one approach, the home automation controller 40 may provide a graphical user interface to a user, for example, on a display connected to the receiving device 10 to permit the user to control and customize various aspects of the ambient light effects.

The lighting devices 14, 16, 24, 26, 44, and 46 can be any type of household or commercial devices capable of producing visible light. For example only, the lighting devices may be stand-alone lamps, track lights, recessed lights, wall-mounted lights or the like. The lighting devices 14, 16 are preferably adapted to be dimmed. The lighting devices 14, 16 have been shown in FIG. 1 as being identical for example only, and it is to be appreciated that the receiving device 10 can be simultaneously connected to two, three, four, or more types of different lighting devices.

Further, it is to be appreciated that the receiving device 10 has been shown in FIG. 1 as being connected to two lighting devices 14 and 16 by way of example only, and that the receiving device 10 can be connected to any number of lighting devices suitable for a given room where the receiving device 10 is located. In one exemplary approach, the receiving device 10 may be connected to only one lighting device. In another approach, the receiving device 10 may be connected to four lighting devices each located in a corner of a room. In another approach, the receiving device 10 may be connected to at least two lighting devices located in front of a user, at least two lighting devices located on right and left sides of the user, and at least two lighting devices located behind the user so as to create a surround ambient light effect for the user.

With reference to FIG. 6, the receiving device 10 is adapted for parsing a digital video signal or a digital video file incoming from the video source 12. For example only, the receiving device 10 may include a processor 13 that is programmed to parse an incoming digital video signal or digital video file. For purposes of this application, the term “processor” will be understood to mean any hardware component capable of parsing the incoming digital video signal or digital video file. For example, the processor 13 may be a graphics card, a decoder, or the like.

FIG. 6 shows an exemplary digital video stream 50 incoming from the video source 12 and being received by the receiving device 10. The digital video stream 50 includes a digital video file 52 and a digital audio file 54. The digital video stream 50 also includes additional ALE tracks 56 including data specifying at least one ambient light effect associated with one or more portions or scenes of the program, movie, or game contained in the digital video file 52. The ALE tracks 56 can also include data specifying at least one lighting device for generating the at least one ambient light effect specified in the ALE tracks 56.

When the digital video stream 50 is received by the receiving device 10 from the video source 12, the processor 13 of the receiving device 10 performs the parsing of the digital video file 52 to separate one or more ALE tracks 56 and detect data representing one or more ambient light effects included in the ALE tracks 56. The processor 13 of the receiving device 10 is also programmed to produce and send one or more commands to one or more lighting devices to generate the one or more ambient light effects specified in one or more ALE tracks 56. For example only, the processor 13 can cause the receiving device 10 to send a first command 58 to the lighting device 14 to generate a first ambient light effect specified in the ALE track 56 and send a second command 60 to the lighting device 16 to generate a second ambient light effect specified in the ALE track 56. The first and second ambient light effects may be the same or different.

The receipt of the commands 58 and 60 by the lighting devices 14 and 16 causes the lighting devices 14 and 16 to generate the ambient light effects specified in the commands 58 and 60. As such, the ambient light effects specified in the ALE tracks 56 are generated by the lighting devices 14 and 16, preferably when the one or more portions of the digital video file 52 associated with one or more ambient light effects specified in the ALE tracks 56 are displayed to the user. The generation of the ambient light effects by the lighting devices 14 and 16 in association with scenes, action sequences, or events specified in the ALE tracks 56 creates an enhanced and visually pleasing experience for a user watching a television program, a movie, or playing a video game.

In one approach, each of the ALE tracks 56 can further include an identification of the lighting device to generate the ambient light effect specified in the ALE track 56. In particular, the ALE tracks 56 can specify a predetermined location of the lighting device for generating the ambient light effect relative to the receiving device 10. By way of example only, if a character in a war movie observes a flash of a grenade in front of the character, the ALE track 56 can specify that a lighting device facing the user generate the ambient light effect specified in the ALE track 56 for the grenade flash. Alternatively, if the user is playing a first-person-shooter video game and the user's character gets shot at from behind or the side, the ALE track 56 can specify that a lighting device located behind or on the side of the user generate the ambient light effect specified in the ALE track 56 for such a shooting attack.

In one approach, each of the ALE tracks 56 can also include a predetermined time when the at least one ambient light effect specified in a respective ALE track 56 is to be generated by a lighting device specified in the respective ALE track 56. By way of example only, the predetermined time may be set such that the ambient light effect is generated by an appropriate lighting device not only while the scene or event in the movie contained in the video file 52 is displayed to the user, but where appropriate, last an additional one or two seconds more after the scene or event is no longer displayed to the user.

In another approach, each of the ALE tracks 56 can also include data specifying brightness of the ambient light effect to be generated by one or more lighting device. By way of example, an ambient light effect generated during the display of a scene showing mid-day sunlight can be visibly brighter to a user than an ambient light effect generated during the display of a scene taking place at dusk or dawn.

The ambient light effects specified in the ALE tracks 56 can be associated with any portion of the video file 52. For example, portions of the video file 52 with which an ambient light effect can be associated include, but are not limited to, background settings (day, night, outdoor, indoor, etc.), action sequences (e.g., car chases, explosions, fights, etc.), specific events (e.g., a character is born, a character goes to sleep or wakes up, a character dies, etc.). By way of example only, the lighting devices can generate a low light ambient light effect for an action sequence taking place inside of a dark room and switch to a bright light ambient light effect for a next action sequence taking place when the characters exit from the dark room to a sun-filled parking lot.

As discussed above, in one approach, a graphical user interface is provided to a user to permit the user to configure one or more options for controlling the generation of the ambient light effects by the lighting devices. This advantageously results in a more personal and enhanced experience for each specific user.

In another aspect of the invention, a method of making a video file specifying at least one ambient light effect is also provided. With reference to FIG. 6, the method comprises writing one or more ALE tracks 56 to a video file 52. Each of the ALE tracks 56 specifies at least one ambient light effect associated with at least one portion (e.g., a specific scene or a specific event in a movie) of the video file 52. In one approach, the method also includes each of the ALE tracks 56 identifying one or more lighting devices for generating the one or more ambient light effect specified in a respective ALE track 56.

With continued reference to FIG. 6, the method further includes sending the one or more ALE tracks 56 associated with the video file 52 to the receiving device 10. As discussed above, the receiving device 10 can include a processor 13 and is adapted to parse the video file 52 to separate the one or more ALE tracks 56. The receiving device 10 is also adapted to send one or more commands (e.g., 58 and 60) to one or more lighting devices (e.g., 14 and 16) specified in a respective ALE track 56 to generate one or more ambient light effects specified in the respective ALE track 56.

In an approach, the method can include specifying in an ALE track 56 a predetermined location of one or more lighting devices 14 and 16 relative to the receiving device 10. In another approach, the method can include specifying in the ALE track 56 a predetermined time when one or more ambient light effects associated with one or more portions of the video file 52 are to be generated by a respective one of the lighting devices 14 and 16. In yet another approach, the method can also include specifying in the ALE track 56 a brightness level and/or rate of flickering of the ambient light effect to be generated by one or more of the lighting devices 14 and 16.

In one approach, the method can further include specifying in the ALE track 56 a predetermined event in a video contained in the video file 52 which is associated with the ambient light effect. The method can also include specifying in the ALE track 56 that display of a predetermined event on a display device of a user simultaneously causes generation of the ambient light effect specified in the ALE track 56 by one or more lighting devices 14 and 16. In another approach, the method can further include specifying in the ALE track 56 a predetermined sound or sounds contained in the audio file 54 associated with the video file 52 such that when the user hears the predetermined sound, the ambient light effect associated with that sound is generated.

In one approach, the method includes providing authoring or rendering software adapted to provide for the creation of ALE tracks 56 associated with one or more portions of the video file 52, for the writing of the ALE tracks 56 to the video file 52, and for the reading and/or parsing of the ALE tracks 56 previously written to the video file 52. Such software can be provided both at a point of origin of the video file 52 such as a cable head-end, or integrated into the receiving device 10, or both. The authoring software thus can be a helpful tool for both a content provider and a content user.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

What is claimed is:

1. A method of controlling ambient light effects, the method comprising:
providing a receiving device configured to parse an incoming video file;
receiving the video file at the receiving device, the video file including at least one track specifying at least one ambient light effect associated with at least one portion of the video file and specifying at least one lighting device for generating the at least one ambient light effect specified in the at least one track;
parsing the video file at the receiving device to separate the at least one track specifying the at least one ambient light effect and the at least one lighting device;
sending a command to generate the at least one ambient light effect specified in the at least one track from the receiving device to the at least one lighting device specified in the at least one track; and
causing the at least one lighting device specified in the at least one track, and receiving the command, to generate the at least one ambient light effect specified in the at least one track when the at least one portion of the video file associated with the at least one ambient light effect is displayed.

2. The method of claim 1, wherein the receiving device is selected from one of a television, set-top box, disc player, personal computer, laptop, tablet computer, gaming console, and mobile phone.

3. The method of claim 1, further comprising providing the receiving device including at least one hardware component programmed to parse the video file to separate the at least one track specifying the at least one ambient light effect.

4. The method of claim 1, further comprising providing at least one software component adapted for inserting the at least one track specifying the at least one ambient light effect into the video file.

5. The method of claim 1, wherein the at least one track further includes a predetermined location of the at least one lighting device relative to the receiving device.

6. The method of claim 1, wherein at least one track includes a predetermined time when the at least one ambient light effect is to be generated by the at least one lighting device.

7. The method of claim 1, wherein the at least one track includes at least one of brightness and rate of flickering of the at least one ambient light effect to be generated by the at least one lighting device.

8. The method of claim 1, wherein the at least one portion of the video file is a predetermined event in a video contained in the video file, the predetermined event being associated with the at least one ambient light effect.

9. The method of claim 1, further comprising providing a graphical user interface permitting a user to configure one or more options for controlling generation, by the at least one lighting device, of the at least one ambient light effect included in the at least one track.

10. The method of claim 1, wherein the sending a command from the receiving device to the at least one lighting device includes sending the command from the receiving device to the at least one lighting device via a wired connection.

11. The method of claim 1, wherein the sending a command from the receiving device to the at least one lighting device includes sending the command from the receiving device to the at least one lighting device via a wireless connection.

12. The method of claim 1, wherein the sending a command from the receiving device to the at least one lighting device includes sending the command from the receiving device to the at least one lighting device via a home automation system.

13. A method of making a video file specifying at least one ambient light effect, the method comprising:
writing at least one track into a video file, the video track specifying at least one ambient light effect associated with at least one portion of the video file and identifying at least one lighting device for generating the at least one ambient light effect specified in the at least one track;
sending the at least one track in the video file to a receiving device adapted to parse the video file to separate the at least one track, and to send a command to the at least one lighting device specified in the at least one track to generate the at least one ambient light effect specified in the at least one track.

14. The method of claim 13, further comprising specifying, in the at least one track, a predetermined location of the at least one lighting device relative to the receiving device.

15. The method of claim 13, further comprising specifying, in the at least one track, a predetermined time when the at least one ambient light effect is to be generated by the at least one lighting device.

16. The method of claim 13, further comprising specifying, in the at least one track, at least one of brightness and rate of flickering of the at least one ambient light effect to be generated by the at least one lighting device.

17. The method of claim 13, further comprising specifying, in the at least one track, a predetermined event in a video contained in the video file, the predetermined event in the video being associated with the at least one ambient light effect.

18. The method of claim 17, further comprising specifying in the at least one track, that display of the predetermined event on a display device of a user simultaneously causes generation of the at least one ambient light effect by the at least one lighting device.

19. A system for controlling ambient light effects comprising:
a receiving device including at least one hardware component including a processor programmed to parse an incoming video file to separate at least one track specifying at least one ambient light effect associated with at least one portion of the video file;
at least one lighting device in communication with the receiving device;
wherein the at least one track specifies the at least one lighting device for generating the at least one ambient light effect;
wherein the processor of the receiving device is programmed to send a command from the receiving device to the at least one lighting device specified in the track to generate the at least one ambient light effect; and
wherein the at least one lighting device includes at least one hardware component adapted to, after receiving the command from the receiving device, to generate the at least one ambient light effect when the at least one portion of the video file associated with the at least one ambient light effect is displayed to a user.

20. The system of claim 19, wherein the receiving device is selected from one of a television, set-top box, disc player, personal computer, laptop, tablet computer, and mobile phone.
